(19) United States
(12) Patent Application Publication
(10) Pub. No.: US 2009/0135099 A1
(43) Pub. Date: May 28, 2009

(54) Plasma display device and driving method thereof

(76) Inventors: Hyungu Heo, Yongin-si (KR); Hoyoung Ahn, Yongin-si (KR); Kwangsig Jung, Yongin-si (KR); Kyongwon Kim, Yongin-si (KR)

Correspondence Address: LEE & MORSE, P.C., 3141 FAIRVIEW PARK DRIVE, SUITE 500, FALLS CHURCH, VA, 22042, US

(21) Appl. No.: 12/292,201

(22) Filed: Nov. 13, 2008

(30) Foreign Application Priority Data
Nov. 28, 2007 (KR) 10-2007-0122189

(51) Int. Cl. G09G 3/28

(52) U.S. Cl. 345/60

(57) ABSTRACT

A plasma display device and a driving method thereof includes a controller configured to receive an input image signal, to generate address, scan and sustain control signals, and to divide one frame into a plurality of sub-field. The controller checks sub-fields in which address power consumption exceeds a reference value among the plurality of sub-fields to generate a scan control signal of a scan mode such that the scan pulses are applied only odd-numbered scan electrodes or even-numbered scan electrodes among the scan electrodes with respect to the sub-fields in which the address power consumption exceeds the reference value, and to generate an address control signal of rearranging address data such that the address pluses are applied to the address electrodes in accordance with the scan mode of the scan electrodes.

### BACKGROUND OF THE INVENTION

1. Field of the Invention

Embodiments relate to a plasma display device capable of reducing address power consumption and a driving method of the plasma display device.

2. Description of the Related Art

A plasma display device is a flat panel display device for displaying characters or images using plasma produced by gas discharge. A plurality of address electrodes, a plurality of scan electrodes and a plurality of sustain electrodes are formed in a display panel of the plasma display device, and discharge cells are formed at intersection points of the address, scan and sustain electrodes.

Generally, in a plasma display panel of a plasma display device, one frame is divided into a plurality of sub-fields having respective weights to be driven, and each of the sub-fields includes a reset period, an address period and a sustain period. The reset period is a period in which discharge cells are initialized to stably perform address discharge. The address period is a period in which cells to be turned on and off are selected in the plasma display panel. The sustain period is a period in which sustain discharge for actually displaying an image is performed with respect to the turned-on cells.

When operations of the respective sub-fields are performed as described above, a discharge space between scan and sustain electrodes, between substrates with address and sustain electrodes formed thereon, or the like serves as a capacitive load. For this reason, capacitance exists in the plasma display panel.

Therefore, in order to apply a waveform for addressing, reactive power for injecting charges, which generates a predetermined voltage in a capacitor, is increased as well as address power for address discharge. However, if data are frequently changed in an address electrode as in a dot pattern screen, the number of switching times in the address electrode is increased. For this reason, more address power may be consumed.

### SUMMARY OF THE INVENTION

Embodiments are therefore directed to a plasma display device and a driving method thereof, which substantially overcome one or more of the problems and disadvantages of the related art.

It is therefore a feature of an embodiment to provide a plasma display device capable of reducing address power consumption and a driving method of the plasma display device.

It is therefore another feature of an embodiment to provide a plasma display device capable of rearranging address data to reduce the number of switching times in address electrodes and a driving method of the plasma display device.

At least one of the above and other features and advantages may be realized by providing a plasma display device including a controller configured to receive an input image signal, to divide one frame into a plurality of sub-fields, and to generate address, scan and sustain control signals, a driver configured to generate address, scan and sustain pulses respectively in accordance with the address, scan, and sustain control signals, and a plasma display panel having a plurality of address, scan, and sustain electrodes, the plasma display panel being driven by the address, scan, and sustain pulses, wherein the controller is configured to check sub-fields in which address power consumption exceeds a reference value among the plurality of sub-fields to generate a scan control signal of a scan mode such that the scan pulses are applied only to odd-numbered scan electrodes or even-numbered scan electrodes among the scan electrodes in sub-fields in which the address power consumption exceeds the reference value, and to generate an address control signal rearranging address data such that the address pluses are applied to the address electrodes in accordance with the scan mode of the scan electrodes.

The controller may be configured to generate a scan control signal of a scan mode such that the scan pulses are applied to all the scan electrodes with respect to sub-fields in which the address power consumption is less than the reference value.

The controller may be configured to generate a scan control signal of alternately performing scan modes controlled such that the scan pulses are applied to only the odd-numbered scan electrodes and only the even-numbered scan electrodes for adjacent sub-fields among the subfields in which the address power consumption exceeds the reference value.

The controller may be configured to calculate a sum of differences of sub-field data of adjacent upper/lower lines in a same column to obtain address power consumption for each of the sub-fields, and the reference value is a mean address power consumption of the plurality of sub-fields in the one frame.

The controller may include a sub-field generator configured to convert the image signal into sub-field data and to arrange the address data using the sub-field data, a power consumption checker configured to check sub-fields in which the address power consumption exceeds the reference value using the sub-field data and to generate a signal for the sub-fields in which the address power consumption exceeds the reference value, the signal including at least one of a first signal, a second signal, and a third signal, the first signal applying scan pulses to only odd-numbered scan electrodes, the second signal applying scan pulses to only even-numbered scan electrodes, and the third signal alternately applying scan pulses to only even-numbered scan electrodes and only the odd-numbered scan electrodes, a memory controller configured to rearrange the address data transmitted from the sub-field generator and to generate the address control signal in accordance with the signal from the power consumption checker, a sustain pulse adjuster configured to change, when receiving the signal from the power consumption checker, a number of sustain pulses such that the number of sustain pulses applied to scan electrodes and sustain electrodes is greater than that applied to scan and sustain electrodes when the address power consumption is less than the reference value, a scan controller configured to generate the scan control signal in accordance with the signal from the power consumption checker and the number of sustain pulses from the sustain pulse adjuster, and a sustain controller configured to generate the sustain control signal in accordance with the number of sustain pulses from the sustain pulse adjuster.

The scan controller may be configured to generate a scan control signal such that the even-numbered scan electrodes are not scanned when the first signal is received from the power consumption checker, and generate a scan control signal such that the odd-numbered scan electrodes are not scanned when the second signal is received from the power consumption checker.

The scan controller may be configured to generate a scan control signal such that the number of scan pulses applied to the odd-numbered scan electrodes with respect to the sub-fields in which the address power consumption exceeds the reference value is two times greater than that applied to the odd-numbered scan electrodes with respect to the sub-fields in which the address power consumption is less than the reference value when the first signal is received from the power consumption checker, and generate a scan control signal such that the number of scan pulses applied to the even-numbered scan electrodes with respect to the sub-fields in which the address power consumption exceeds the reference value is two times greater than that applied to the even-numbered scan electrodes with respect to the sub-fields in which the address power consumption is less than the reference value when the second signal is received from the power consumption checker.

When the signal is received from the power consumption checker, the sustain pulse adjuster may be configured to change a number of sustain pulses applied to scan electrodes and sustain electrodes corresponding to the scan electrodes to be twice that applied to scan and sustain electrodes in which the address power consumption is less than the reference value.

At least one of the above and other features and advantages may be realized by providing a driving method of a plasma display device including a plasma display panel having a plurality of address, scan, and sustain electrodes, the plasma display panel being driven by dividing one frame into a plurality of sub-fields in accordance with an input image signal, the method including checking sub-fields in which address power consumption exceeds a reference value among the plurality of sub-fields, generating a scan control signal of a scan mode such that scan pulses are applied only odd-numbered scan electrodes or even-numbered scan electrodes among the scan electrodes with respect to the sub-fields in which the address power consumption exceeds the reference value, and rearranging address data such that address pulses are applied to the address electrodes in accordance with the scan mode of the scan electrodes.

Checking sub-fields may include, when address power consumption exceeds a reference value among the plurality of sub-fields, generating at least one of a first signal applying scan pulses to only odd-numbered scan electrodes, a second signal applying scan pulses to only even-numbered scan electrodes, and a third signal alternately applying scan pulses to only even-numbered scan electrodes and only odd-numbered scan electrodes.

The method may further include adjusting, in accordance with one of the first, second, and third signals, a number of sustain pulses such that the number of sustain pulses applied to scan electrodes and sustain electrodes is greater than that applied to scan and sustain electrodes when the address power consumption is less than the reference value, generating the scan control signal includes generating the scan control signal in accordance with one of the first, second and third signals and an adjusted number of sustain pulses, and generating a sustain control signal in accordance with the adjusted number of sustain pulses.

Generating the scan control signal may include not scanning even-numbered scan electrodes when receiving the first signal, and not scanning odd-numbered scan electrodes when receiving the second signal.

Generating the scan control signal may include, in response to the first signal, applying twice as many scan pulses to the odd-numbered scan electrodes in sub-fields in which the address power consumption exceeds the reference value as that applied when address power consumption is less than the reference value, and, in response to the second signal, applying twice as many scan pulses to the even-numbered scan electrodes in sub-fields in which the address power consumption exceeds the reference value as that applied when the address power consumption is less than the reference value.

Generating the scan control signal may include applying twice as many sustain pulses to scan electrodes corresponding to sustain electrodes as that applied to scan electrodes in which the address power consumption is less than the reference value.

The method may include supplying a driving signal including the address, scan and sustain pulses to the plasma display panel.

Checking the address power consumption may include generating a fourth signal applying scan pulses to all the scan electrodes with the sub-fields in which the address power consumption is less than the reference value.

Checking sub-fields may include calculating a sum of differences of sub-field data of adjacent upper/lower lines in a same column to obtain address power consumption for each of the sub-fields, and the reference value may be a mean address power consumption of the plurality of sub-fields in the one frame.

At least one of the above and other features and advantages may be realized by providing a controller for use with a plasma display device, the controller configured to receive an image signal input, divide one frame into a plurality of sub-fields, generate address, scan and sustain control signals to be output to the plasma display device, check sub-fields in which address power consumption exceeds a reference value among the plurality of sub-fields, generate a scan control signal of a scan mode such that the scan pulses are applied to only odd-numbered scan electrodes or even-numbered scan electrodes among the scan electrodes with respect to the sub-fields in which the address power consumption exceeds the reference value, and generate an address control signal such that address pulses are applied to the address electrodes in accordance with the scan mode of the scan electrodes.

The controller may be configured to, when address power consumption exceeds a reference value among the plurality of sub-fields, generate at least one of a first signal applying scan pulses to only odd-numbered scan electrodes, a second signal applying scan pulses to only even-numbered scan electrodes, and a third signal alternately applying scan pulses to only even-numbered scan electrodes and only odd-numbered scan electrodes.

The controller may be configured to adjust, in accordance with one of the first, second, and third signals, a number of sustain pulses such that the number of sustain pulses applied to scan electrodes and sustain electrodes is greater than that applied to scan and sustain electrodes when the address power consumption is less than the reference value, generate the scan control signal n accordance with one of the first, second and third signals and an adjusted number of sustain pulses, and generate a sustain control signal in accordance with the adjusted number of sustain pulses.

### BRIEF DESCRIPTION OF THE DRAWINGS

The above and other features and advantages will become more apparent to those of ordinary skill in the art by describing in detail exemplary embodiments with reference to the attached drawings, in which:

FIG. 1 illustrates a block diagram of a plasma display device according to an embodiment of the present invention;

FIG. 2 illustrates is a detailed block diagram of a controller in FIG. 1 according to a first embodiment;

FIG. 3 illustrates an exemplary view of a dot pattern image data;

FIG. 4 illustrates a conceptual view of an application order of scan pulses and an application order of address pulses when address power consumption exceeds a reference value in the plasma display device according to an embodiment of the present invention;

FIG. 5 illustrates a conceptual view of another application order of scan pulses and another application order of address pulses when the address power consumption exceeds the reference value in the plasma display device according to an embodiment of the present invention;

FIG. 6 illustrates a conceptual view of an application order of scan pulses and an application order of address pulses when the address power consumption is less than the reference value in the plasma display device according to an embodiment of the present invention;

FIG. 7 illustrates an exemplary view comparing, for the same sub-field, the number of sustain pulses assigned when the address power consumption is less than the reference value with the number of sustain pulses assigned when the address power consumption exceeds the reference value;

FIG. 8 illustrates a detailed block diagram of a controller of a plasma display device according to a second embodiment of the present invention;

FIG. 9 illustrates a detailed block diagram of a controller of a plasma display device according to a third embodiment of the present invention;

FIG. 10 illustrates a conceptual view of an application order of scan pulses and an application order of address pulses when address power consumption exceeds a reference value in the plasma display device having the controller in FIG. 9;

FIG. 11 illustrates a detailed block diagram of a controller of a plasma display device according to a fourth embodiment of the present invention;

FIG. 12 illustrates a conceptual view of an application order of scan pulses and an application order of address pulses when address power consumption exceeds a reference value in the plasma display device having the controller in FIG. 11; and

FIG. 13 illustrates a flowchart of a driving method of a plasma display device according to an embodiment of the present invention.

### DETAILED DESCRIPTION OF THE INVENTION

Korean Patent Application No. 10-2007-0122189, filed on Nov. 28, 2007, in the Korean Intellectual Property Office, and entitled: “Plasma Display Device and Driving Method Thereof,” is incorporated by reference herein in its entirety.

Example embodiments will now be described more fully hereinafter with reference to the accompanying drawings; however, they may be embodied in different forms and should not be construed as limited to the embodiments set forth herein. Rather, these embodiments are provided so that this disclosure will be thorough and complete, and will fully convey the scope of the invention to those skilled in the art.

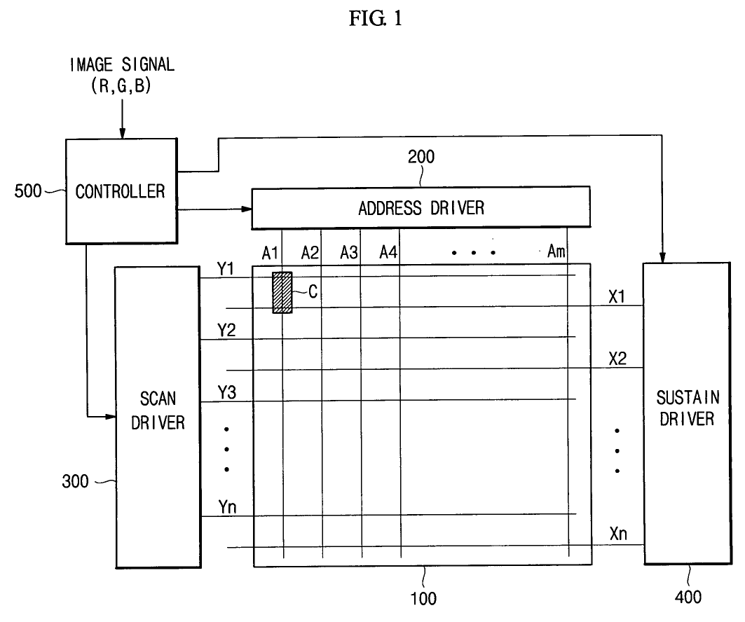

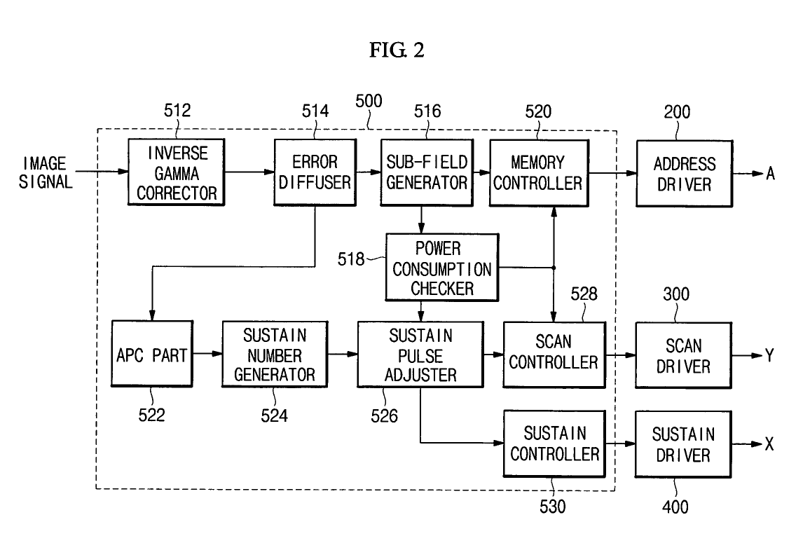

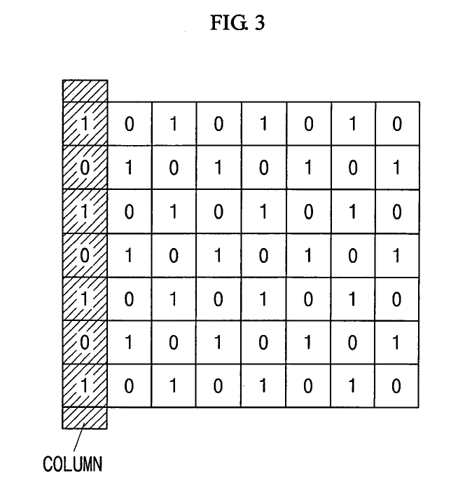

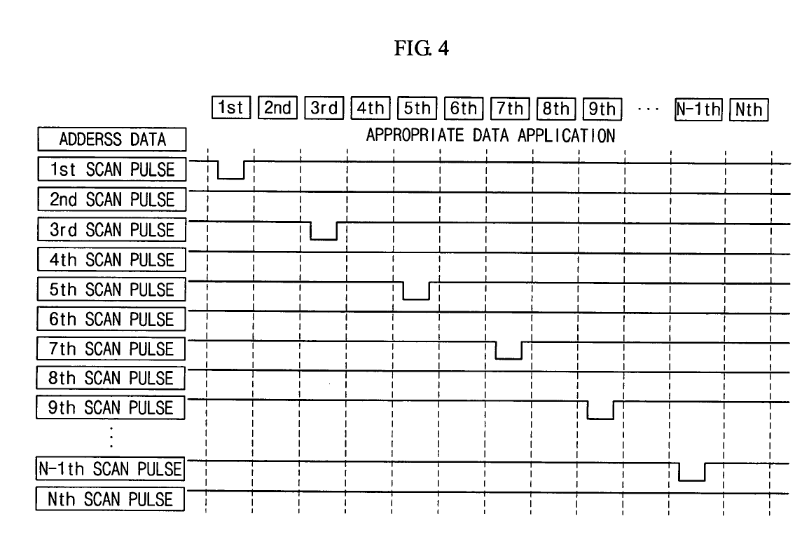

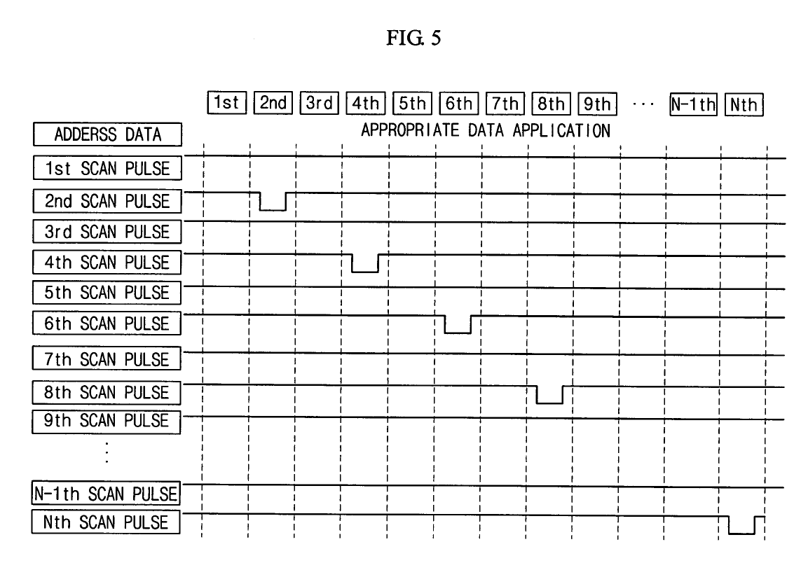

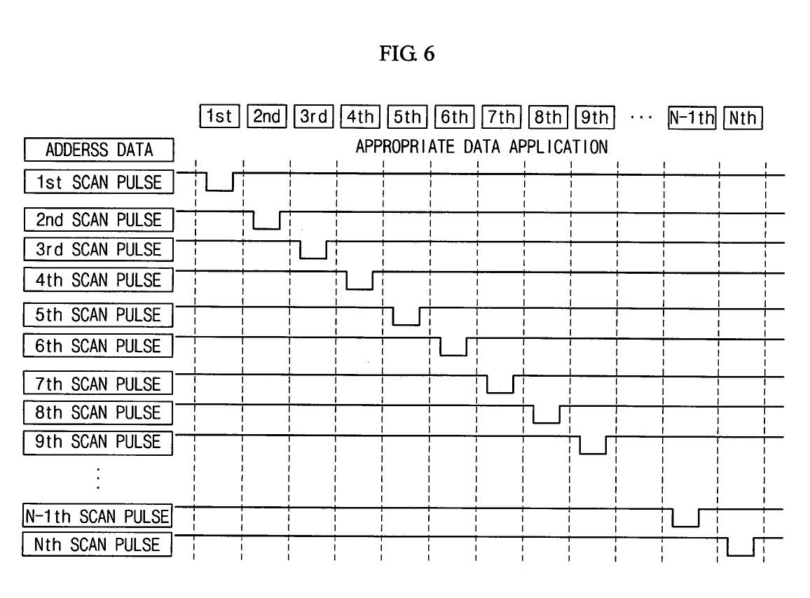

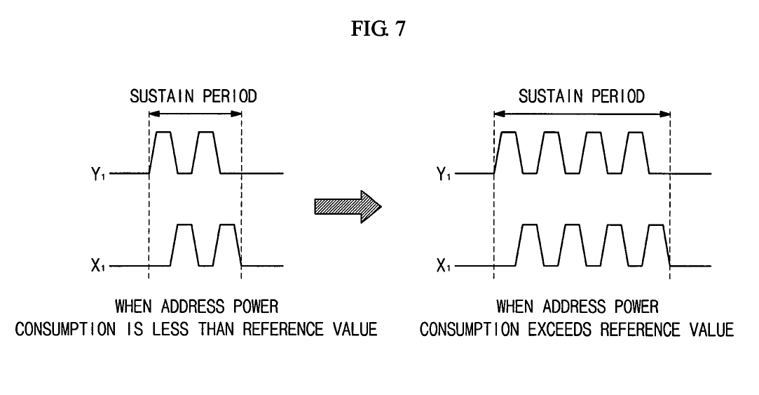

FIG. 1 illustrates a block diagram showing a plasma display device according to an embodiment of the present invention. FIG. 2 illustrates a block diagram showing in detail a controller in FIG. 1 according to a first embodiment. FIG. 3 illustrates an exemplary view showing a dot pattern image data. FIG. 4 illustrates a conceptual view of an application order of scan pulses and an application order of address pulses when address power consumption exceeds a reference value in the plasma display device according to the first embodiment. FIG. 5 illustrates a conceptual view of another application order of scan pulses and another application order of address pulses when the address power consumption exceeds the reference value in the plasma display device according to the one embodiment of the present invention. FIG. 6 illustrates a conceptual view of an application order of scan pulses and an application order of address pulses when the address power consumption is less than the reference value in the plasma display device according to the one embodiment of the present invention. FIG. 7 illustrates a comparison, for the same sub-field, the number of sustain pulses assigned when the address power consumption is less than the reference value with the number of sustain pulses assigned when the address power consumption exceeds the reference value.

Referring to FIG. 1, the plasma display device according an embodiment of the present invention may include a plasma display panel 100, an address driver 200, a scan driver 300, a sustain driver 400, and a controller 500.

The plasma display panel 100 may display an image using a plurality of discharge cells C arrayed in a matrix form. The discharge cells C may be defined by a plurality of address electrodes A1 to Am extending in a column direction, a plurality of scan electrodes Y1 to Yn extending in a row direction, and a plurality of sustain electrodes X1 to Xn extending in the row direction, sustain electrodes X1 to Xn and the scan electrodes Y1 to Yn being arranged in pairs. Here, the address electrodes A1 to Am may intersect the scan electrodes Y1 to Yn and the sustain electrodes X1 to Xn.

The address driver 200 may supply data signals for selecting discharge cells to be displayed to the address electrodes A1 to Am in response to address control signals from the controller 500. The scan driver 300 may apply driving voltages to the scan electrodes Y1 to Yn in response to scan control signals from the controller 500. The sustain driver 400 may apply driving voltages to the sustain electrodes X1 to Xn in response to sustain control signals from the controller 500.

In the controller 500, one frame may be divided into a plurality of sub-fields to be driven. Each of the sub-fields may include a reset period, an address period and a sustain period. The controller 500 may receive vertical/horizontal synchronization signals to generate address, scan, and sustain control signals required in the respective drivers 200, 300 and 400. The generated control signals may be respectively supplied to the drivers 200, 300 and 400, so that the controller 500 controls the respective drivers 200, 300 and 400.

The controller 500 in accordance with a first embodiment will be described in detail with reference to FIG. 2. The controller 500 may include an inverse gamma corrector 512, an error diffuser 514, a sub-field generator 516, a power consumption checker 518, a memory controller 520, an auto power control (APC) part 522, a sustain number generator 524, a sustain pulse adjuster 526, a scan controller 528, and a sustain controller 530. Through such a configuration, the controller 500 may rearrange address data of an address pulse applied to the address electrodes with respect to sub-fields in which address power consumption exceeds a reference value to reduce the number of switching times in the address electrodes, thereby reducing the address power consumption.

The inverse gamma corrector 512 may map an input image signal to an inverse gamma curve to correct the input image signal into an image signal, bits of which are changed. For example, an RGB signal of n bits may be mapped to the inverse gamma curve to correct the RGB image signal into an image signal of m bits (m>n). In a general plasma display device, n may be 8 and m may be 10 or 12.

The image signal input to the inverse gamma corrector 512 is a digital signal. When an analog image signal is input to the plasma display device, the analog image signal may be converted into a digital image signal by an analog-to-digital converter (not shown). The inverse gamma corrector 512 may include a logic circuit (not shown) for generating data corresponding to the inverse gamma curve for mapping an image signal through logical operation.

The error diffuser 514 may error diffuse a subordinate m-n bit image in an image of m bits inverse-gamma corrected and extended by the inverse gamma corrector 512 into peripheral pixels to be displayed. Error diffusion is a method of separating an image of subordinate bits to be error diffused and diffusing the image into adjacent pixels, thereby displaying the image of the subordinate bits. Since the error diffusion is readily understood by those skilled in the art, a detailed description thereof will be omitted.

The sub-field generator 516 may generate sub-fields corresponding to gray levels of image data output from the error diffuser 514 and may generate sub-field data corresponding to the sub-fields. Sub-field data generated by the sub-field generator 516 may be transmitted to the power consumption checker 518 and the memory controller 520, which will be described in detail below.

The power consumption checker 518 may determine whether or not sub-field data transmitted from the sub-field generator 516 requires much power consumption. Data requiring much power consumption include a large number of switching times in the address electrodes. For example, data requiring much power consumption are frequently generated when address data (i.e., sub-field data) in adjacent lines (rows) within the same column are different from each other. Such data may be, e.g., dot pattern data, illustrated in FIG. 3, or line pattern data (not shown).

Since a switching state is changed when one of two discharge cells adjacent in a column direction is turned on and the other is turned off, address power consumption may be calculated as the total sum of on/off data in the two discharge cells adjacent in the column direction, as expressed by Equation 1:

$$AP = {\sum }_{i = 1}^{n - 1} {\sum }_{j = 1}^{m} ( \vert {R}_{ij} - {R}_{( i + 1 ) j} \vert + \vert {G}_{ij} - {G}_{( i + 1 )} \vert + \vert {B}_{ij} - {B}_{( i + 1 )} \vert ) \qquad ( 1 )$$

Here, Rᵢⱼ, Gᵢⱼ and Bᵢⱼ are on/off data of red (R), green (G) and blue (B) discharge cells of i^{th} row and j^{th} column, respectively.

Since image signals are generally input in series in order of lines, the power consumption checker 518 may include a line memory (not shown) for storing an image signal of one line so as to calculate a difference of on/off data between adjacent two discharge cells. If on/off data for each sub-field is input with respect to an image signal of one line, the power consumption checker 518 may sequentially store the on/off data in the line memory and may read data of the previous line stored in the line memory to calculate a difference of on/off data for each sub-field in the adjacent two discharge cells. Then, the power consumption checker 518 may add the calculated results for each sub-field with respect to all the discharge cells to obtain address power consumption as the total sum of the calculated results. The power consumption checker 518 may calculate a difference of on/off data for each sub-field in adjacent two discharge cells, e.g., through an exclusive OR (XOR) operation of the on/off data.

The power consumption checker 518 may calculate address power consumption for each sub-field, e.g., using Equation 1. When the calculated power consumption for each sub-field exceeds a reference value, the power consumption checker 518 may output a signal, e.g., a first signal or a second signal, for a scan mode to the memory controller 520, the sustain pulse adjuster 526, and scan controller 528, which will be described below. The reference value may be, for example, a mean address power consumption of a plurality of sub-fields in the one frame.

When the image signal input for each sub-field requires much address power consumption, i.e., when the image signal exceeds the reference value, the signal output from the power consumption checker 518 may correspond to a signal to be scanned in an interlaced mode. In such an interlaced mode, the power consumption checker 518 may output the first signal such that scan pulses are applied to only odd-numbered scan electrodes Y1, Y3, . . . , Yn-1 as shown in FIG. 4, or the power consumption checker 518 may output the second signal such that scan pulses are applied to only even-numbered scan electrodes Y2, Y4, . . . , Yn as shown in FIG. 5.

When the image signal input for each sub-field requires less address power consumption, i.e., when the image signal is less than the reference value, the signal output from the power consumption checker 518 may correspond to a signal to be scanned in a progressive mode. In such a progressive mode, the power consumption checker 518 may output a fourth signal such that scan pluses are applied to both the odd-numbered scan electrodes Y1, Y3, . . . , Yn-1 and the even-numbered scan electrodes Y2, Y4, . . . , Yn, as shown in FIG. 6. The signal may be transmitted to the memory controller 520, the sustain pulse adjuster 526, and the scan controller 528.

The memory controller 520 may rearrange sub-field data from the sub-field generator 516 as address data for driving the plasma display panel 100 and output the rearranged sub-field data to the address driver 200. Specifically, the memory controller 520 may store address data for each of the plurality of sub-fields contained in one frame in a frame memory (not shown) and may output address data for all pixels for each sub-field from the frame memory to the read address data to the address driver 200.

When the memory controller 520 receives a signal for a scan mode transmitted from the power consumption checker 518 as described above, the memory controller 520 may rearrange the address data suitable for the scan mode. If the memory controller 520 receives the first signal from the power consumption checker 518, the memory controller 520 may rearrange the address data such that address pulses are assigned to odd-numbered address electrodes A1, A3, . . . , Am-1, as shown in FIG. 4. If the memory controller 520 receives the second signal from the power consumption checker 518, the memory controller 520 may rearrange the address data such that address pulses are assigned to even-numbered address electrodes A2, A4, . . . , Am, as shown in FIG. 5. If the memory controller 520 receives the fourth signal from the power consumption checker 518, the memory controller 520 may rearrange the address data such that the address pulses are assigned to both the odd-numbered address electrodes A1, A3, . . . , Am-1 and the even-numbered address electrodes A2, A4, . . . , Am, as shown in FIG. 6.

The memory controller 520 may generate address control signals corresponding to the rearranged address data and may supply the generated address control signals to the address driver 200. Then, the address driver 200 may apply address pulses corresponding to the address control signals to the respective address electrodes A1 to Am. As such, the memory controller 520 may rearrange the address data depending on a scan mode of the scan electrodes Y1 to Yn, so that the address driver 200 may reduce the number of switching times in the address electrodes A1 to Am.

The APC part 522 may detect a load factor using image data output from the error diffuser 514, calculate an APC level in accordance with the detected load factor, and then calculate the number of sustain pluses corresponding to the calculated APC level to be output. The sustain number generator 524 may assign the number of sustain pulses for each sub-field using information on the number of sustain pulses transmitted from the APC part 522.

The sustain pulse adjuster 526 may receive information on the number of sustain pulses assigned to each sub-field from the sustain number generator 524. If the sustain pulse adjuster 526 receives the first signal transmitted from the power consumption checker 518, e.g., when address power consumption exceeds a reference value, the sustain pulse adjuster 526 may change a number of sustain pulses applied to the scan and sustain electrodes Y1 and X1 during a sustain period to be greater than that assigned to the scan and sustain electrodes Y1 and X1 during the sustain period when the address power consumption is less than the reference value. For example, as shown in FIG. 7, for the purpose of luminance compensation, the number of sustain pulses assigned to the scan and sustain electrodes Y1 and X1 during the sustain period when address power consumption is greater than the reference value may be twice that assigned to the scan and sustain electrodes Y1 and X1 during the sustain period when the address power consumption is less than the reference value. Since scan pulses are applied to only the odd-numbered scan electrodes Y1, Y3, . . . , Yn-1 or only the even-numbered scan electrodes Y2, Y4, . . . , Yn with respect to sub-fields in which the address power consumption exceeds the reference value, i.e., in the interlaced mode, the luminance is lower than when scan pulses are applied in the progressive mode to sub-fields in which the address power consumption is less than the reference value.

The scan controller 528 may generate a signal for a scan mode received from the power consumption checker 518 and a scan control signal corresponding to the information on the number of sustain pulses received from the sustain pulse adjuster 526, and may supply the generated signals to the scan driver 300. Then, the scan driver 300 may apply scan pulses corresponding to the scan control signal to the scan electrode Y1 to Yn. As such, the scan controller 528 may control scan pulses to be applied to only the odd-numbered scan electrodes Y1, Y3, . . . , Yn-1 or the even-numbered scan electrodes Y2, Y4, . . . , Yn through the scan driver 300 with respect to sub-fields in which the address power consumption exceeds the reference value.

The sustain controller 530 may generate a sustain control signal corresponding to the information on the number of sustain pulses received from the sustain pulse adjuster 526 to supply the generated sustain control signal to the sustain driver 400. Then, the sustain driver 400 may apply sustain pulses corresponding to the sustain control signal to the sustain electrodes X1 to Xn.

As described above, in the plasma display device according to the first embodiment of the present invention, a scan mode in which scan pulses are applied to only the odd-numbered scan electrodes or the even-numbered scan electrodes with respect to sub-fields in which address power consumption exceeds a reference value may be applied by the controller 500 to rearrange address data of address pulses applied to the address electrodes, thereby reducing the number of switching times in the address electrodes. Accordingly, the plasma display device according to the first embodiment of the present invention may reduce address power consumption.

Further, in the plasma display device according to the first embodiment of the present invention, when an interlaced mode is set by the controller 500 with respect to sub-fields in which address power consumption exceeds a reference value, the number of sustain pulses in the sub-fields in which the address power consumption exceeds the reference value may be increased, thereby compensating for luminance degradation that may occur in the sub-fields operating in the interlaced mode.

Hereinafter, a plasma display device according to a second embodiment of the present invention will be described.

The plasma display device according to the second embodiment of the present invention has the same configuration as the plasma display device according to the first embodiment of the present invention. However, operation of some components of a controller 600 in the plasma display device according to the second embodiment of the present invention are different from those of the controller 500 in the plasma display device according to the first embodiment of the present invention. Accordingly, those components of the controller 600 according to the second embodiment that are different from those of the controller 500 of the first embodiment may be designated by different reference numerals, while the same components may be designated by the same reference numerals. The following description of the second embodiment will primarily focus on these different components. Some description of the same components will not be repeated.

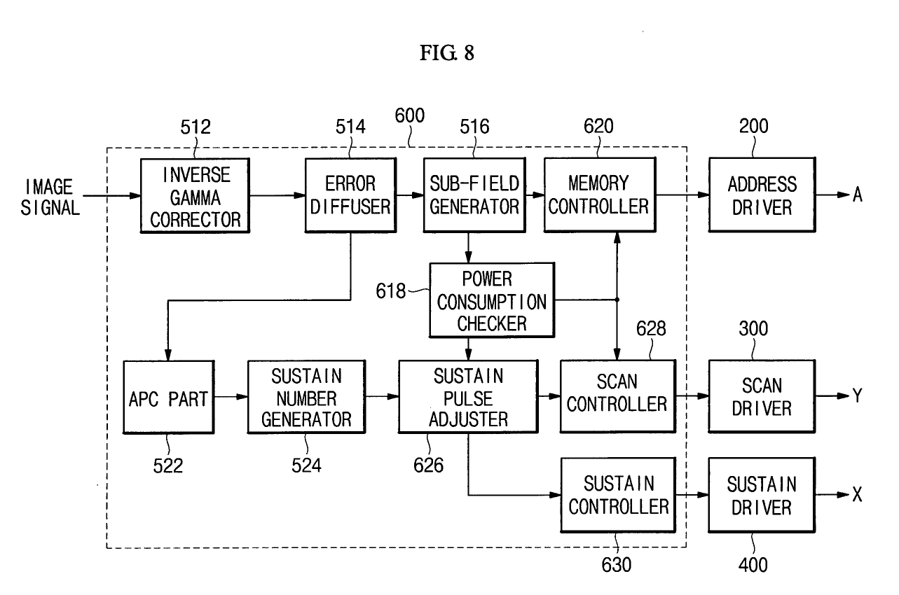

FIG. 8 illustrates a detailed block diagram of the controller 600 of a plasma display device according to another embodiment of the present invention.

Referring to FIG. 8, the controller 600 of the plasma display device according to the second embodiment of the present invention may include the inverse gamma corrector 512, the error diffuser 514, the sub-field generator 516, a power consumption checker 618, a memory controller 620, the APC part 522, the sustain number generator 524, a sustain pulse adjuster 626, a scan controller 628, and a sustain controller 630. Through such a configuration, the controller 600 may rearrange address data of an address pulse applied to the address electrodes with respect to sub-fields in which address power consumption exceeds a reference value to reduce the number of switching times in the address electrodes, thereby reducing the address power consumption.

The power consumption checker 618 may calculate address power consumption for each sub-field, e.g., using Equation 1. When the calculated address power consumption for each sub-field exceeds the reference value, the power consumption checker 618 may output a signal, e.g., a third signal, for a scan mode to the memory controller 620, the sustain pulse adjuster 626, and scan controller 628, which will be described later.

When the image signal input for each sub-field requires much address power consumption, i.e., when the image signal exceeds the reference value, the signal output from the power consumption checker 618 may correspond to a signal to be scanned in an interlaced mode. In the interlaced mode, the power consumption checker 618 may output the third signal such that scan pulses are applied to only odd-numbered scan electrodes Y1, Y3, . . . , Yn-1 with respect to adjacent sub-fields among a plurality of sub-fields in which the address power consumption exceeds the reference value, e.g., arbitrary sub-fields, as shown in FIG. 4, and scan pulses are then applied to only even-numbered scan electrodes Y2, Y4, . . . , Yn-1 with respect to the next sub-fields of the arbitrary sub-fields, as shown in FIG. 5, or the power consumption checker 618 may output the third signal such that scan pulses are applied to only the even-numbered scan electrodes Y2, Y4, . . . , Yn with respect to arbitrary sub-fields, as shown in FIG. 5 and scan pulses are then applied to the odd-numbered scan electrodes Y1, Y3, . . . Yn-1 with respect to the next sub-fields of the arbitrary sub-fields, as shown in FIG. 4.

When the image signal input for each sub-field requires less address power consumption, i.e., when the image signal is less than the reference value, the signal output from the power consumption checker 618 may correspond to a signal to be scanned in a progressive mode. In the progressive mode, the power consumption checker 618 may output the fourth signal such that scan pluses are applied to both the odd-numbered scan electrodes Y1, Y3, . . . , Yn-1 and the even-numbered scan electrodes Y2, Y4, . . . , Yn, as shown in FIG. 6. The signal may be transmitted to the memory controller 620, the sustain pulse adjuster 626, and the scan controller 628.

The memory controller 620 may rearrange sub-field data from the sub-field generator 516 as address data for driving the plasma display panel 100 to supply the rearranged sub-field data to the address driver 200. Here, when the memory controller 620 receives a signal for a scan mode transmitted from the power consumption checker 618 as described above, the memory controller 620 may control the address data to be rearranged suitable for the scan mode in a process of rearranging the sub-field data as the address data. For example, when the memory controller 620 receives the third signal (i.e., the signal output such that scan pulses are applied to only odd-numbered scan electrodes Y1, Y3, . . . , Yn-1 with respect to adjacent sub-fields among a plurality of sub-fields in which the address power consumption exceeds the reference value, e.g., arbitrary sub-fields, as shown in FIG. 4 and scan pulses are then applied to only even-numbered scan electrodes Y2, Y4, . . . , Yn-1 with respect to the next sub-fields of the arbitrary sub-fields as shown in FIG. 5) from the power consumption checker 618, the memory controller 620 may rearrange address data such that address pulses are assigned to odd-numbered address electrodes A1, A3, . . . Am-1 with respect to arbitrary sub-fields among the plurality of sub-fields in which the address power consumption exceeds the reference value and address pulses are then assigned to even-numbered electrodes A2, A4, . . . , Am with respect to the next sub-fields of the arbitrary sub-fields.

When the memory controller 620 receives the fourth signal from the power consumption checker 618, the memory controller 620 may rearrange address data such that address pluses are applied to both the odd-numbered address electrodes A1, A3, . . . , Am-1 and the even-numbered address electrode electrodes A2, A4, . . . , Am as shown in FIG. 6.

The memory controller 620 may generate address control signals corresponding to the rearranged address data to supply the generated address control signals to the address driver 200. Then, the address driver 200 may apply address pulses corresponding to the address control signals to the respective address electrodes A1 to Am. As such, the memory controller 620 may rearrange the address data depending on a scan mode of the scan electrodes Y1 to Yn, so that the address driver 200 may reduce the number of switching times in the address electrodes A1 to Am.

The sustain pulse adjuster 626 may receive information on the number of sustain pulses assigned to each sub-field from the sustain number generator 524. If the sustain pulse adjuster 626 receives the third signal transmitted from the power consumption checker 618, the sustain pulse adjuster 626 may change a number of sustain pluses applied to the scan electrodes Y1 to Yn and the sustain electrodes X1 to Xn during a sustain period to be greater, e.g., two times greater, than that of sustain pulses assigned to the scan electrodes Y1 to Yn and the sustain electrodes X1 to Xn during the sustain period for the purpose of luminance compensation when the address power consumption is less than the reference value.

The scan controller 628 may generate a signal for a scan mode received from the power consumption checker 618 and a scan control signal corresponding to the information on the number of sustain pulses received from the sustain pulse adjuster 626 to supply the generated signals to the scan driver 300. Then, the scan driver 300 may apply scan pulses corresponding to the scan control signal to the scan electrode Y1 to Yn. As such, the scan controller 628 may alternately perform scan modes in which scan pulses are applied to only the odd-numbered scan electrodes Y1, Y3, . . . , Yn-1 and only the even-numbered scan electrodes Y2, Y4, . . . , Yn through the scan driver 300 with respect to adjacent sub-fields among sub-fields in which the address power consumption exceeds the reference value. Accordingly, the scan controller 628 may control the scan electrodes Y1 to Yn to be entirely used.

The sustain controller 630 may generate a sustain control signal corresponding to the information on the number of sustain pulses received from the sustain pulse adjuster 626 to supply the generated sustain control signal to the sustain driver 400. Then, the sustain driver 400 may apply sustain pulses corresponding to the sustain control signal to the sustain electrodes X1 to Xn.

As described above, in the plasma display device according to the second embodiment of the present invention, scan modes in which applying scan pulses to only the odd-numbered scan electrodes and only the even-numbered scan electrodes with respect to adjacent sub-fields among sub-fields in which address power consumption exceeds a reference value may be alternately performed by the controller 600 to rearrange address data of address pulses applied to the address electrodes, thereby reducing the number of switching times in the address electrodes. Accordingly, the plasma display device according to the second embodiment of the present invention may reduce address power consumption.

Further, in the plasma display device according to the second embodiment of the present invention, scan electrodes may all be used by the controller 600, thereby effectively utilizing the scan electrodes. Accordingly, the plasma display device according to the second embodiment of the present invention may enhance resolution.

Hereinafter, a plasma display device according to a third embodiment of the present invention will be described.

The plasma display device according to the third embodiment of the present invention has the same configuration as the plasma display device according to the first embodiment of the present invention. However, operations of some components of a controller 700 in the plasma display device according to the second embodiment of the present invention are different from those of some components of the controller 500 according to the first embodiment of the present invention. Accordingly, some components of the controller 700 different from those of the controller 500 may be designated by different reference numerals. Some components of the controller 700 in the plasma display device according to the third embodiment of the present invention will be mainly described. Some descriptions overlapping with the aforementioned descriptions will not be repeated.

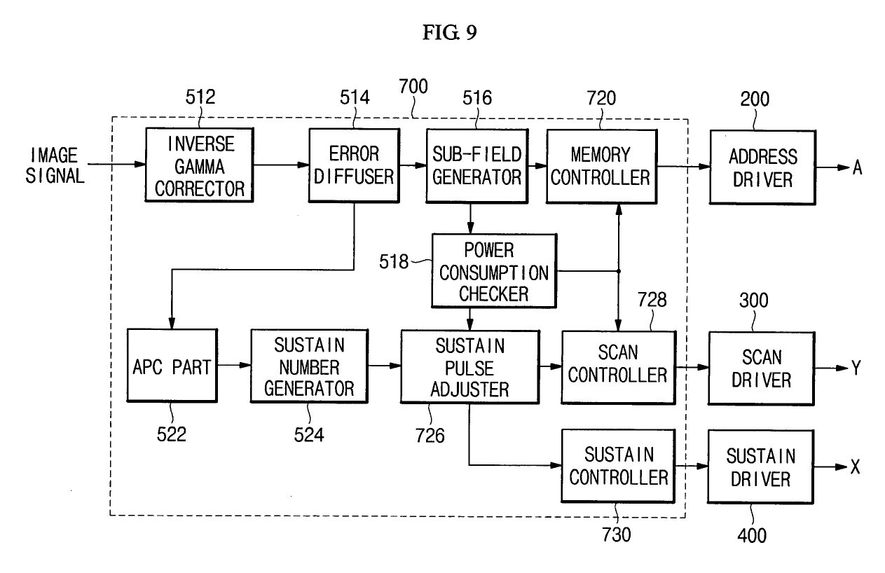

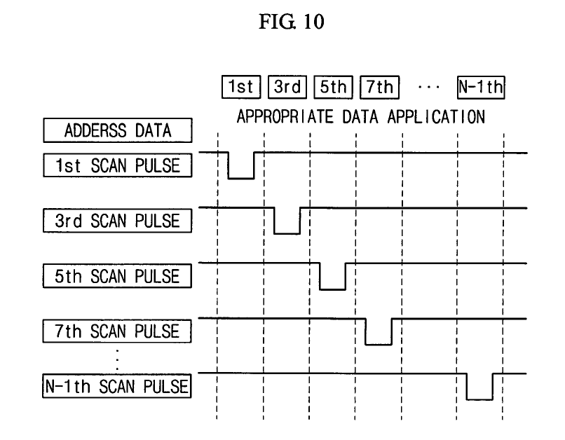

FIG. 9 illustrates a block diagram showing in detail the controller 700 of a plasma display device according to the third embodiment of the present invention. FIG. 10 illustrates a conceptual a view of an application order of scan pulses and an application order of address pulses when address power consumption exceeds a reference value in the plasma display device having the controller in FIG. 9.

Referring to FIGS. 9 and 10, the controller 700 of the plasma display device according to the third embodiment may include the inverse gamma corrector 512, the error diffuser 514, the sub-field generator 516, the power consumption checker 518, a memory controller 720, the APC part 522, the sustain number generator 524, a sustain pulse adjuster 726, a scan controller 728, and a sustain controller 730. Through such a configuration, the controller 700 may rearrange address data of an address pulse applied to the address electrodes with respect to sub-fields in which address power consumption exceeds a reference value to reduce the number of switching times in the address electrodes, thereby reducing the address power consumption.

The memory controller 720 may rearrange sub-field data from the sub-field generator 516 as address data for driving the plasma display panel 100 and may supply the rearranged sub-field data to the address driver 200. When the memory controller 720 receives a signal for a scan mode transmitted from the power consumption checker 518 as described above, the memory controller 720 may control the address data to be rearranged suitable for the scan mode in a process of rearranging the sub-field data as the address data. For example, when the signal is the first signal such that scan pulses are applied to only odd-numbered scan electrodes Y1, Y3, . . . , Yn-1 with sub-fields in which address power consumption exceeds a reference value, the memory controller 720 may rearrange address data such that address pulses are applied to only odd-numbered address electrodes A1, A3, . . . , Am-1 with the sub-fields in which the address power consumption exceeds the reference value as shown in FIG. 10.

The memory controller 720 may generate address control signals corresponding to the rearranged address data to supply the generated address control signals to the address driver 200. Then, the address driver 200 may apply address pulses corresponding to the address control signals to the respective address electrodes A1 to Am. As such, the memory controller 720 may rearrange the address data depending on a scan mode of the scan electrodes Y1 to Yn, so that the address driver 200 may reduce the number of switching times in the address electrodes A1 to Am.

The sustain pulse adjuster 726 may receive information on the number of sustain pulses assigned to each sub-field from the sustain number generator 524. For example, if the sustain pulse adjuster 726 receives the first signal from the power consumption checker 518, the sustain pulse adjuster 726 may change the number of sustain pluses such that the number of sustain pulses applied to the odd-numbered scan electrodes Y1, Y3, . . . , Yn-1 and the odd-numbered sustain electrodes X1, X3, . . . Xn-1 during a sustain period is greater, e.g., two times greater, than that assigned to the odd-numbered scan electrodes Y1, Y3, . . . , Yn-1 and the odd-numbered sustain electrodes X1, X3, . . . Xn-1 during the sustain period when the address power consumption is less than the reference value.

The scan controller 728 may generate a signal for a scan mode received from the power consumption checker 518 and a scan control signal corresponding to the information on the number of sustain pulses received from the sustain pulse adjuster 726 and may supply the generated signals to the scan driver 300. Then, the scan driver 300 may apply scan pulses corresponding to the scan control signal to the scan electrode Y1 to Yn. When the scan controller 728 receives the first signal from the power consumption checker 518, the scan controller 728 may generate a scan control signal which omits scanning of the even-numbered scan electrodes Y2, Y4, . . . , Yn, as may be seen in FIG. 10, unlike the scan mode in FIG. 4. Accordingly, the scan controller 728 may reduce scanning time of the scan electrodes Y1 to Yn.

The sustain controller 730 may generate a sustain control signal corresponding to the information on the number of sustain pulses received from the sustain pulse adjuster 726 to supply the generated sustain control signal to the sustain driver 400. Then, the sustain driver 400 applies sustain pulses corresponding to the sustain control signal to the sustain electrodes X1 to Xn.

As described above, in the plasma display device according to the third embodiment of the present invention, with respect to sub-fields in which in which address power consumption exceeds a reference value, the controller 700 may apply scan pulses to only the odd-numbered scan electrodes or may apply scan pulses to only the even-numbered scan electrodes, may not apply scan pulses to remaining scan electrodes. Thus, address data of address pulses applied to the address electrodes may be rearranged, thereby reducing the number of switching times in the address electrodes and reducing scanning time of the scan electrodes.

Accordingly, the plasma display device according to the third embodiment of the present invention may reduce address power consumption and may secure sufficient time when the twice as many sustain pulses are applied in sub-fields in which the address power consumption exceeds the reference value by reducing scanning time.

Hereinafter, a plasma display device according a fourth embodiment of the present invention will be described.

The plasma display device according to the fourth embodiment of the present invention has the same configuration as the plasma display device according to the first embodiment of the present invention. However, operations of some components of a controller 800 in the plasma display device according to the fourth embodiment of the present invention are different from those of some components of the controller 500 in the plasma display device according to the first embodiment of the present invention. Accordingly, some components of the controller 800 according to the fourth embodiment different from those of the controller 500 may be designated by different reference numerals. Some components of the controller 800 will be mainly described. Some descriptions overlapping the aforementioned descriptions may not be repeated.

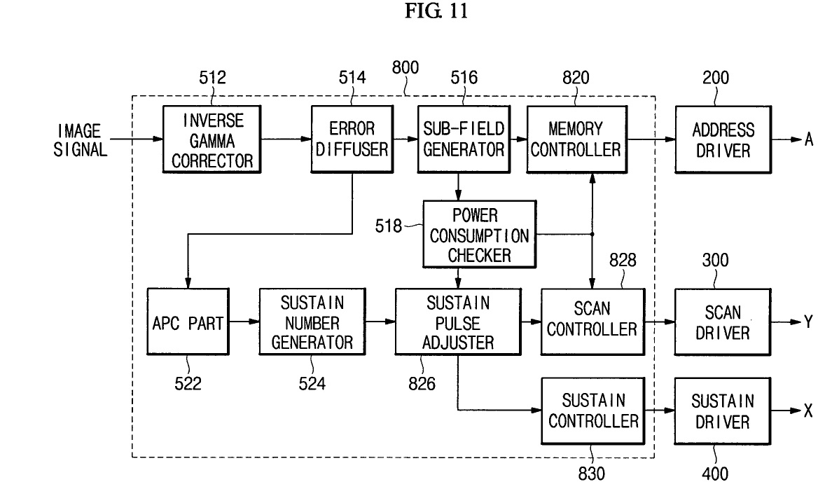

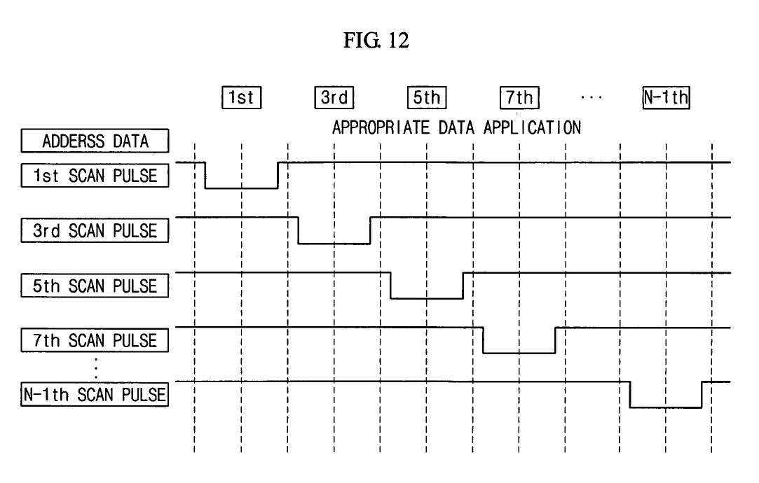

FIG. 11 illustrates a block diagram showing in detail the controller 800 of a plasma display device according to the fourth embodiment of the present invention. FIG. 12 illustrates a conceptual view of an application order of scan pulses and an application order of address pulses when address power consumption exceeds a reference value in the plasma display device having the controller 800 in FIG. 11.

Referring to FIGS. 11 and 12, the controller 800 of the plasma display device according to the fourth embodiment may include the inverse gamma corrector 512, the error diffuser 514, the sub-field generator 516, the power consumption checker 518, a memory controller 820, the APC part 522, the sustain number generator 524, a sustain pulse adjuster 826, a scan controller 828, and a sustain controller 830. Through such a configuration, the controller 800 may rearrange address data of an address pulse applied to the address electrodes with respect to sub-fields in which address power consumption exceeds a reference value to reduce the number of switching times in the address electrodes, thereby reducing the address power consumption.

The memory controller 820 may rearrange sub-field data from the sub-field generator 516 as address data for driving the plasma display panel 100 to supply the rearranged sub-field data to the address driver 200. When the memory controller 820 receives a signal for a scan mode transmitted from the power consumption checker 518 as described above, the memory controller 820 may control the address data to be rearranged suitable for the scan mode in a process of rearranging the sub-field data as the address data. For example, when the signal is the first signal, scan pulses are applied to only odd-numbered scan electrodes Y1, Y3, . . . , Yn-1 with sub-fields in which address power consumption exceeds a reference value, the memory controller 820 may rearrange address data such that address pulses are applied to only odd-numbered address electrodes A1, A3, . . . , Am-1 with the sub-fields in which the address power consumption exceeds the reference value as shown in FIG. 12.

The memory controller 820 may generate address control signals corresponding to the rearranged address data to supply the generated address control signals to the address driver 200. Then, the address driver 200 may apply address pulses corresponding to the address control signals to the respective address electrodes A1 to Am. As such, the memory controller 820 may rearrange the address data depending on a scan mode of the scan electrodes Y1 to Yn, so that the address driver 200 may reduce the number of switching times in the address electrodes A1 to Am.

The sustain pulse adjuster 826 may receive information on the number of sustain pulses assigned to each sub-field from the sustain number generator 524. For example, if the sustain pulse adjuster 826 receives the first signal transmitted from the power consumption checker 518, the sustain pulse adjuster 826 may change the number of sustain pluses such that the number of sustain pulses applied to the odd-numbered scan electrodes Y1, Y3, . . . , Yn-1 and the odd-numbered sustain electrodes X1, X3, . . . Xn-1 during a sustain period is greater, e.g., two times greater, than that of sustain pulses assigned to the odd-numbered scan electrodes Y1, Y3, . . . , Yn-1 and the odd-numbered sustain electrodes X1, X3, . . . Xn-1 during the sustain period when the address power consumption is less than the reference value.

The scan controller 828 may generate a signal for a scan mode received from the power consumption checker 518 and a scan control signal corresponding to the information on the number of sustain pulses received from the sustain pulse adjuster 826 and output the generated signals to the scan driver 300. Then, the scan driver 300 may apply scan pulses corresponding to the scan control signal to the scan electrode Y1 to Yn. When the scan controller 828 receives the first signal from the power consumption checker 518, the scan controller 828 may generate a scan control signal which omits scanning of even-numbered lines, as illustrated in FIG. 12, unlike the scan mode in FIG. 4. Accordingly, the scan controller 828 may reduce scanning time. When the scan controller 828 receives the first signal from the power consumption checker 518, the scan controller 828 may generate a scan control signal having an increased scanning time, e.g., double scanning time, in each line of the odd-numbered scan electrodes Y1, Y3, . . . , Yn-1, such that a period during which light is emitted is not changed during a sustain period. That is, the scan controller 828 may control the number of pulses applied to the odd-numbered scan electrodes Y1, Y3, . . . , Yn-1 to be greater than, e.g., twice, that assigned to the odd-numbered scan electrodes Y1, Y3, . . . , Yn-1 with respect to sub-fields in which address power consumption less than a reference value.

The sustain controller 830 may generate a sustain control signal corresponding to the information on the number of sustain pulses received from the sustain pulse adjuster 826 to supply the generated sustain control signal to the sustain driver 400. Then, the sustain driver 400 may apply sustain pulses corresponding to the sustain control signal to the sustain electrodes X1 to Xn.

As described above, in the plasma display device according to the fourth embodiment of the present invention, the controller 800 may control a scan mode of the scan electrodes such that scan pulses are applied to only the odd-numbered scan electrodes or the even-numbered scan electrodes with respect to sub-fields in which address power consumption exceeds a reference value, may increase, e.g., double, scanning time and may rearrange address data, thereby reducing the number of switching times in the address electrodes and preventing change of light emitting period.

Accordingly, the plasma display device according to the current embodiment of the present invention may reduce address power consumption by altering on the number of switching times in the address electrodes, and may prevent flicker generated due to the change of the light emitting period.

Hereinafter, a driving method of a plasma display device according to an embodiment of the present invention will be described.

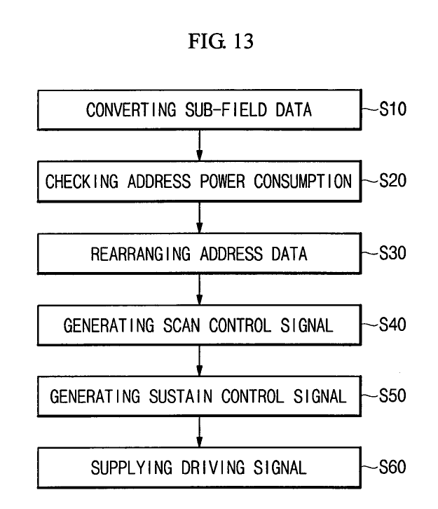

FIG. 13 illustrates a flowchart of a driving method of a plasma display device according to an embodiment of the present invention.

Referring to FIG. 13, the driving method of a plasma display device according to an embodiment of the present invention may include a sub-field data converting operation S10, an address power consumption checking operation S20, an address data rearranging operation S30, a scan control signal generating operation S40, a sustain control signal generating operation S50, and a driving signal supplying operation S60. Since operations shown in FIG. 13 have been described in detail above, they will be briefly described with reference to FIGS. 1 to 12.

The sub-field data converting operation S10 may convert image signals input to the controller 500, 600, 700, and 800 from the outside into sub-field data and rearranging address data using the sub-field data.

The address power consumption checking operation S20 may check sub-fields in which address power consumption exceeds a reference value using the sub-field data. The sub-fields in which the address power consumption exceeds the reference value are checked based on whether or not the sum of differences of sub-field data of adjacent upper/lower lines in the same column exceeds the reference value in each sub-field. If sub-fields in which the address power consumption exceeds the reference value are checked, the first signal of a scan mode may be generated such that scan pulses are applied to only odd-numbered scan electrodes among the scan electrodes, the second signal of a scan mode may be generated such that the scan pulses are applied to only even-numbered scan electrodes among the scan electrodes, and/or the third signal of alternately performing scan modes may be generated such that the scan pulses are applied to only even-numbered scan electrodes and only the odd-numbered scan electrodes among the scan electrodes with respect to adjacent sub-fields among the sub-fields in which the address power consumption exceeds the reference value. The fourth signal of a scan mode in which the scan pulses are applied to both the even-numbered and odd-numbered scan electrodes with respect to sub-fields in which the address power consumption is less than the reference value may also be generated.

The address data rearranging operation S30 may rearrange the address data such that the address pulses applied to address electrodes correspond to any one selected from the first, second, and third signals. An address control signal corresponding to the rearranged address data may be supplied to the address driver 200.

The scan control signal generating operation S40 may generate a scan control signal such that the sub-fields in which the address power consumption exceeds the reference value may be scanned in an interlaced mode. For example, in the scan control signal generating operation S40, a scan control signal may be generated such that the scan pulses are applied to only the odd-numbered scan electrodes Y1, Y3, . . . , Yn-1 with respect to the sub-fields in which the address power consumption exceeds the reference value, and the number of sustain pulses applied to the odd-numbered scan electrodes Y1, Y3, . . . , Yn-1 with respect to the sub-fields in which the address power consumption exceeds the reference value is greater, e.g., two times, greater than that of sustain pulses assigned to the odd-numbered scan electrodes Y1, Y3, . . . , Yn-1 with respect to sub-fields in which the address power consumption is less than the reference value. In addition, the scan control signal may not apply scan pulses to the even-numbered scan electrodes Y2, Y4, . . . , Yn.

Alternatively, the scan control signal generating operation S40 may generate a scan control signal for controlling such that the scan pulses are applied to only the even-numbered scan electrodes Y2, Y4, . . . , Yn with respect to the sub-fields in which the address power consumption exceeds the reference value, and the number of sustain pulses applied to the even-numbered scan electrodes Y2, Y4, . . . , Yn with respect to the sub-fields in which the address power consumption exceeds the reference value is greater, e.g., two times greater, than that of sustain pulses assigned to the even-numbered scan electrodes Y2, Y4, . . . , Yn with respect to sub-fields in which the address power consumption is less than the reference value. In addition, the scan control signal may include not applying scan pulses to the odd-numbered scan electrodes Y1, Y3, . . . , Yn-1 is not performed. Alternatively, in the scan control signal generating operation S40, a scan control signal for alternately performing scan modes may be generated such that the scan pulses are applied to only even-numbered scan electrodes and only the odd-numbered scan electrodes with respect to adjacent sub-fields among the sub-fields in which the address power consumption exceeds the reference value. The scan control signal may be supplied to the scan driver 300.

The sustain control signal generating operation S50 may generate a sustain control signal such that the number of sustain pulses applied to the sustain electrodes corresponding to the scan electrodes of the sub-fields in which the address power consumption exceeds the reference value is greater, e.g., two times greater, than that of sustain pulses applied to the sustain electrodes of the sub-fields in which the address power consumption is less than the reference value.

The driving signal supplying operation S60 may apply a driving signal including address, scan and sustain pulses to a plasma display panel, thereby driving the plasma display panel.

Exemplary embodiments of the present invention have been disclosed herein, and although specific terms are employed, they are used and are to be interpreted in a generic and descriptive sense only and not for purpose of limitation. Accordingly, it will be understood by those of ordinary skill in the art that various changes in form and details may be made without departing from the spirit and scope of the present invention as set forth in the following claims.

What is claimed is:

1. A plasma display device, comprising:
a controller configured to receive an input image signal, to divide one frame into a plurality of sub-fields, and to generate address, scan and sustain control signals;
a driver configured to generate address, scan and sustain pulses respectively in accordance with the address, scan, and sustain control signals; and
a plasma display panel having a plurality of address, scan, and sustain electrodes, the plasma display panel being driven by the address, scan, and sustain pulses,
wherein the controller is configured to check sub-fields in which address power consumption exceeds a reference value among the plurality of sub-fields to generate a scan control signal of a scan mode such that the scan pulses are applied only to odd-numbered scan electrodes or even-numbered scan electrodes among the scan electrodes in sub-fields in which the address power consumption exceeds the reference value, and to generate an address control signal rearranging address data such that the address pluses are applied to the address electrodes in accordance with the scan mode of the scan electrodes.

2. The plasma display device as claimed in claim 1,
wherein the controller is configured to generate a scan control signal of a scan mode such that the scan pulses are applied to all the scan electrodes with respect to sub-fields in which the address power consumption is less than the reference value.

3. The plasma display device as claimed in claim 1,
wherein the controller is configured to generate a scan control signal of alternately performing scan modes controlled such that the scan pulses are applied to only the odd-numbered scan electrodes and only the even-numbered scan electrodes for adjacent sub-fields among the subfields in which the address power consumption exceeds the reference value.

4. The plasma display device as claimed in claim 1,
wherein the controller is configured to calculate a sum of differences of sub-field data of adjacent upper/lower lines in a same column to obtain address power consumption for each of the sub-fields, and the reference value is a mean address power consumption of the plurality of sub-fields in the one frame.

5. The plasma display device as claimed in claim 4, wherein the controller comprises:
a sub-field generator configured to convert the image signal into sub-field data and to arrange the address data using the sub-field data;
a power consumption checker configured to check sub-fields in which the address power consumption exceeds the reference value using the sub-field data and to generate a signal for the sub-fields in which the address power consumption exceeds the reference value, the signal including at least one of a first signal, a second signal, and a third signal, the first signal applying scan pulses to only odd-numbered scan electrodes, the second signal applying scan pulses to only even-numbered scan electrodes, and the third signal alternately applying scan pulses to only even-numbered scan electrodes and only the odd-numbered scan electrodes;
a memory controller configured to rearrange the address data transmitted from the sub-field generator and to generate the address control signal in accordance with the signal from the power consumption checker;
a sustain pulse adjuster configured to change, when receiving the signal from the power consumption checker, a number of sustain pulses such that the number of sustain pulses applied to scan electrodes and sustain electrodes is greater than that applied to scan and sustain electrodes when the address power consumption is less than the reference value;
a scan controller configured to generate the scan control signal in accordance with the signal from the power consumption checker and the number of sustain pulses from the sustain pulse adjuster; and
a sustain controller configured to generate the sustain control signal in accordance with the number of sustain pulses from the sustain pulse adjuster.

6. The plasma display device as claimed in claim 5, wherein the scan controller is configured to:
generate a scan control signal such that the even-numbered scan electrodes are not scanned when the first signal is received from the power consumption checker, and
generate a scan control signal such that the odd-numbered scan electrodes are not scanned when the second signal is received from the power consumption checker.

7. The plasma display device as claimed in claim 6, wherein the scan controller is configured to:
generate a scan control signal such that the number of scan pulses applied to the odd-numbered scan electrodes with respect to the sub-fields in which the address power consumption exceeds the reference value is two times greater than that applied to the odd-numbered scan electrodes with respect to the sub-fields in which the address power consumption is less than the reference value when the first signal is received from the power consumption checker, and
generate a scan control signal such that the number of scan pulses applied to the even-numbered scan electrodes with respect to the sub-fields in which the address power consumption exceeds the reference value is two times greater than that applied to the even-numbered scan electrodes with respect to the sub-fields in which the address power consumption is less than the reference value when the second signal is received from the power consumption checker.

8. The plasma display device as claimed in claim 5, wherein, when the signal is received from the power consumption checker, the sustain pulse adjuster is configured to change a number of sustain pulses applied to scan electrodes and sustain electrodes corresponding to the scan electrodes to be twice that applied to scan and sustain electrodes in which the address power consumption is less than the reference value.

9. A driving method of a plasma display device including a plasma display panel having a plurality of address, scan, and sustain electrodes, the plasma display panel being driven by dividing one frame into a plurality of sub-fields in accordance with an input image signal, the method comprising:
checking sub-fields in which address power consumption exceeds a reference value among the plurality of sub-fields;
generating a scan control signal of a scan mode such that scan pulses are applied only odd-numbered scan electrodes or even-numbered scan electrodes among the scan electrodes with respect to the sub-fields in which the address power consumption exceeds the reference value; and
rearranging address data such that address pulses are applied to the address electrodes in accordance with the scan mode of the scan electrodes.

10. The method as claimed in claim 9, wherein checking sub-fields includes, when address power consumption exceeds a reference value among the plurality of sub-fields:
generating at least one of a first signal applying scan pulses to only odd-numbered scan electrodes, a second signal applying scan pulses to only even-numbered scan electrodes, and a third signal alternately applying scan pulses to only even-numbered scan electrodes and only odd-numbered scan electrodes.

11. The method as claimed in claim 10, further comprising:
adjusting, in accordance with one of the first, second, and third signals, a number of sustain pulses such that the number of sustain pulses applied to scan electrodes and sustain electrodes is greater than that applied to scan and sustain electrodes when the address power consumption is less than the reference value;
generating the scan control signal includes generating the scan control signal in accordance with one of the first, second and third signals and an adjusted number of sustain pulses; and
generating a sustain control signal in accordance with the adjusted number of sustain pulses.

12. The method as claimed in claim 10, wherein generating the scan control signal includes:
not scanning even-numbered scan electrodes when receiving the first signal; and
not scanning odd-numbered scan electrodes when receiving the second signal.

13. The method as claimed in claim 12, wherein generating the scan control signal includes:
in response to the first signal, applying twice as many scan pulses to the odd-numbered scan electrodes in sub-fields in which the address power consumption exceeds the reference value as that applied when address power consumption is less than the reference value, and
in response to the second signal, applying twice as many scan pulses to the even-numbered scan electrodes in sub-fields in which the address power consumption exceeds the reference value as that applied when the address power consumption is less than the reference value.

14. The method as claimed in claim 10, wherein generating the scan control signal includes:
applying twice as many sustain pulses to scan electrodes corresponding to sustain electrodes as that applied to scan electrodes in which the address power consumption is less than the reference value.

15. The method as claimed in claim 9, further comprising:
supplying a driving signal including the address, scan and sustain pulses to the plasma display panel.

16. The method as claimed in claim 9, wherein checking the address power consumption includes generating a fourth signal applying scan pulses to all the scan electrodes with the sub-fields in which the address power consumption is less than the reference value.

17. The method as claimed in claim 9, wherein checking sub-fields includes calculating a sum of differences of sub-field data of adjacent upper/lower lines in a same column to obtain address power consumption for each of the sub-fields, and the reference value is a mean address power consumption of the plurality of sub-fields in the one frame.

18. A controller for use with a plasma display device, the controller configured to:
receive an image signal input;
divide one frame into a plurality of sub-fields;
generate address, scan and sustain control signals to be output to the plasma display device;
check sub-fields in which address power consumption exceeds a reference value among the plurality of sub-fields;
generate a scan control signal of a scan mode such that the scan pulses are applied to only odd-numbered scan electrodes or even-numbered scan electrodes among the scan electrodes with respect to the sub-fields in which the address power consumption exceeds the reference value; and
generate an address control signal such that address pulses are applied to the address electrodes in accordance with the scan mode of the scan electrodes.

19. The controller as claimed in claim 18, wherein the controller is configured to, when address power consumption exceeds a reference value among the plurality of sub-fields, generate at least one of a first signal applying scan pulses to only odd-numbered scan electrodes, a second signal applying scan pulses to only even-numbered scan electrodes, and a third signal alternately applying scan pulses to only even-numbered scan electrodes and only odd-numbered scan electrodes.

20. The controller as claimed in claim 19, wherein the controller is configured to:
adjust, in accordance with one of the first, second, and third signals, a number of sustain pulses such that the number of sustain pulses applied to scan electrodes and sustain electrodes is greater than that applied to scan and sustain electrodes when the address power consumption is less than the reference value;
generate the scan control signal n accordance with one of the first, second and third signals and an adjusted number of sustain pulses; and
generate a sustain control signal in accordance with the adjusted number of sustain pulses.
